(19) United States
(12) Patent Application Publication
(10) Pub. No.: US 2015/0001156 A1
(43) Pub. Date: Jan. 1, 2015

(54) METHODS AND APPARATUS FOR TREATMENT OF LIQUIDS CONTAINING CONTAMINANTS USING ZERO VALENT NANOPARTICLES

(71) Applicant: Corning Incorporated, Corning, NY (US)

(72) Inventor: Benedict Yorke Johnson, Horseheads, NY (US)

(21) Appl. No.: 13/927,857

(22) Filed: Jun. 26, 2013

(51) Int. Cl. B01J 20/32; B01J 20/28; C02F 1/28

(52) U.S. Cl. CPC B01J 20/3295; C02F 1/288; B01J 20/28016; B01J 20/3236; B01J 20/3225; C02F 2101/20
USPC 210/688; 427/180; 427/202; 427/337; 427/372.2; 427/203; 428/307.7; 428/117

(57) ABSTRACT

Methods and apparatus provide for an inorganic substrate having at least one surface having a plurality of pores; zero valent nanoparticles deposited on the at least one surface and within at least some of the pores; and a stabilizer engaging the zero valent nanoparticles and operating to inhibit oxidation of the zero valent nanoparticles.

### BACKGROUND

The present disclosure relates to methods and apparatus for the treatment of liquids containing contaminants using zero valent nanoparticles.

It is clearly desirable to reduce the levels of heavy metals in surface waters, such as streams, rivers and lakes. Such heavy metal contaminants include: cadmium, chromium, copper, lead, mercury, nickel, zinc, and semi-metals such as arsenic and selenium. High concentrations of heavy metals in the environment can be detrimental to a variety of living species, and ingestion of these metals by humans in sufficient quantities can cause accumulative poisoning, cancer, nervous system damage, and ultimately death. Coal-fired power plants and waste incinerators are major sources of heavy metals. Specifically, power plants and incinerators that have flue gas desulfurization systems (wet FGDs) are of concern because wastewater in the purge stream in such systems often contains mercury, selenium and/or arsenic.

Governmental regulations for controlling the discharge of industrial wastewater containing dissolved concentrations of heavy metals into the environment are being tightened. In order to meet such regulations, wastewater is often treated to either remove or reduce such heavy metals to levels at which the water is considered safe for both aquatic and human life prior to discharge of the wastewater into the environment. Conventional treatment processes for removal of heavy metals from water are generally based on chemical precipitation and coagulation followed by conventional filtration. The problem with conventional techniques, however, is that they are not likely to remove sufficient metal concentrations to achieve the low ppb levels required by the ever more stringent drinking water standards set by the government.

Accordingly, there are needs in the art for new methods and apparatus for the treatment of liquids containing contaminants in order to remove some or all of the heavy metals that may be contained in solution.

### SUMMARY

One or more embodiments disclosed herein provide processes and apparatus for reducing heavy metals in wastewater effluents, such as those generated by mineral and/or metal processing systems, coal-fired power plant FGD wastewater, etc. Such embodiments provide an environmentally-compatible and simple process for removing dissolved heavy metals from aqueous solutions without requiring follow up filtration, which can be expensive and difficult to operate.

In particular, one or more embodiments disclosed herein provide for immobilizing and stabilizing zero valent nanoparticles on a substrate and utilizing such a structure to remove heavy metals from wastewater. Nanoparticles have been found to be attractive for remediation of various contaminants because of their unique physiochemical properties, especially their high surface area. Indeed, as nanoparticles are extremely small, a high surface area to mass ratio exists, making them much more reactive compared to coarser predecessors, such as iron filings.

Use of zero valent iron (ZVI) nanoparticles has been emerging as a promising option for removal of heavy metals from industrial wastewaters. ZVI)(Fe⁰) nanoparticles have been used in the electronic and chemical industries due to their magnetic and catalytic properties. Use of ZVI nanoparticles is becoming an increasingly popular method for treatment of hazardous and toxic wastes and for remediation of contaminated water. Conventional applications have focused primarily on the electron-donating properties of ZVI. Under ambient conditions, ZVI is fairly reactive in water and can serve as an excellent electron donor, which makes it a versatile remediation material. ZVI nanoparticles, due to their extremely high effective surface area, can enhance the reduction rates markedly. ZVI nanoparticles have been shown to effectively transform and detoxify a wide variety of common environmental contaminants, such as chlorinated organic solvents, organochlorine pesticides, and PCBs, nitrate, hexavalent chromium and various heavy metal ions.

Despite advances in ZVI nanoparticle technology and modest commercialization, several barriers have prevented its use as a widely adopted remediation option. There are technical challenges that have limited the technology, including problems of synthesis and problems of application. Among the problems in the syntheses of ZVI nanoparticles is the inherent environmental instability of the particles themselves. Without any protection, ZVI nanoparticles are oxidized as soon as they come in contact with air. As to problems of application, in water ZVI nanoparticles behave as any other nanoparticles in that they aggregate and eventually settle, thereby making it difficult to carry out a specific reaction efficiently and effectively. In water treatment and metal recovery applications, ZVI nanoparticles may be employed in powder form, granular form and/or fibrous form in batch reactors and column filters. However, within the reactor or filter the ZVI nanoparticles rapidly fuse into a mass due to formation of iron oxides. This fusion significantly reduces the hydraulic conductivity of the iron bed and the efficacy of the treatment rapidly deteriorates.

Although some have taken steps to overcome these drawbacks, they have proved to be less than acceptable for low cost and practical water treatment applications. For example, one approach has been to immobilize iron nanoparticles on particulate supports, such as silica, sand, alumina, activated carbon, titania, zeolite, etc., in order to prevent ZVI nanoparticle aggregation and rapid deactivation. Although this approach has enhanced the speed and efficiency of remediation, the problem remains that it requires a follow up filtration, just like processes employing free standing ZVI nanoparticles. Filtration methods, including membrane filtration, reverse osmosis, electrodialysis reversal and nanofiltration are expensive and difficult to implement and operate. Further, disposal of the waste that is generated during water treatment and follow up filtration is also problematic because, for example, membranes consistently clog and foul. A further problem is that the use of a particulate support only addresses the agglomeration of ZVI nanoparticles, but offers no protection against the rapid loss of reactivity due to oxidation.

One or more embodiments herein provide for a ceramic monolith structure having one or more porous surfaces that are coated with stabilized, zero valent nanoparticles. The zero valent nanoparticles are stabilized by coating the nanoparticles with protective materials, such as inorganic oxide (e.g., silica, iron oxide, titania, alumina), activated carbon, graphene, etc. The zero valent nanoparticles are deposited on the porous surface of the ceramic such that they engage, and adhere to, the pores of the substrate.

In one or more embodiments, the ceramic monolith is a cellular cordierite honeycomb structure which permits a wastewater stream to flow through the parallel cells of the honeycomb, and come into contact with the zero valent nanoparticles, thereby providing high efficiency heavy metal adsorption. The cellular monolith support offers several advantages over particulate supports, including a high geometric contact surface, structural durability, a low-pressure drop, and uniform flow distribution. Immobilization and stabilization of zero valent nanoparticles on the surfaces of the cells also eliminates the disadvantages of using free-standing nanoparticles, including poor mechanic strength, rapid loss of reactivity and the requirement for follow up filtration.

The advantages of employing a ceramic monolith to support zero valent nanoparticles in water treatment include: (i) reduced complexity (simple equipment), ease of operation and ease of handling before, during after the treatment process; (ii) prevention of zero valent nanoparticle aggregation, and prevention of rapid deactivation, which further enhances the speed and efficiency of remediation; (iii) low cost and minimal use of chemicals because, for example, certain zero valent nanoparticles (e.g., iron) are inexpensive, and the elimination of follow up filtration significantly impacts cost of treatment; and (iv) wide applicability and selectivity as to the metal sorbent(s) to capture.

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is a schematic view of a system for treating contaminated water using immobilized and stabilized zero valent nanoparticles;

FIG. 2 is a schematic view of a structure for immobilizing and stabilizing the zero valent nanoparticles on a substrate;

FIG. 3 is a schematic, microscopic view of a portion of the structure containing the immobilized and stabilized zero valent nanoparticles;

FIG. 4 is a perspective view of an embodiment in which the substrate is implemented using a honeycomb structure; and

FIG. 5 is an end view of the honeycomb structure.

### DETAILED DESCRIPTION OF THE PREFERRED EMBODIMENTS

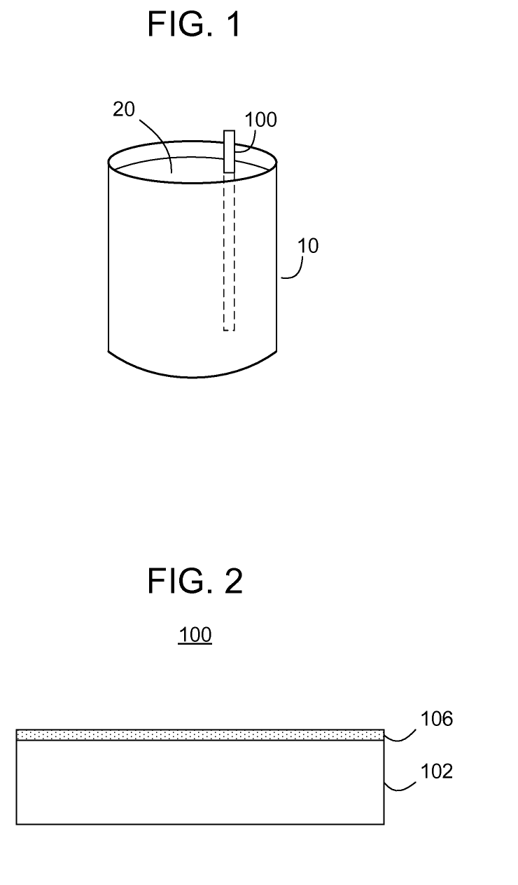

Various embodiments disclosed herein are directed to processes and apparatus for reducing heavy metals in wastewater effluents, such as those generated by mineral and/or metal processing systems, coal-fired power plant FGD wastewater, etc. With reference to FIG. 1, a schematic representation of a treatment system shows a vessel 10, which contains contaminated water 20, and a treatment structure 100 that includes zero valent nanoparticles. The structure 100 is immersed into the contaminated water 20 and agitation is optionally applied until the heavy metals are removed from the water 20, leaving an acceptable level of contaminants (if any) in the water 20.

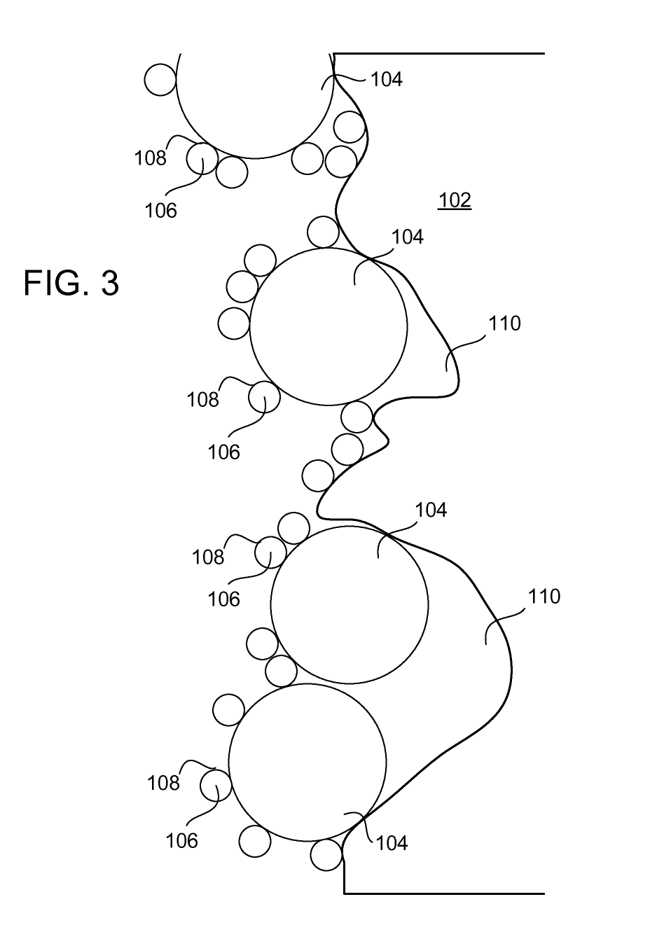

FIG. 2 is a schematic view of the structure 100, and FIG. 3 is a schematic, microscopic view of a portion of the structure 100, provided in order to appreciate certain details concerning the immobilized and stabilized zero valent nanoparticles. The structure 100 includes an inorganic substrate 102 having at least one surface and the zero valent nanoparticles 106 are deposited and immobilized on the surface of the substrate 102. The inorganic substrate may be formed from, for example, ceramic or alumina. A stabilizer 108 engages the zero valent nanoparticles 106 and operates to inhibit oxidation of the zero valent nanoparticles 106. The zero valent nanoparticles 106 include at least one of iron, lithium, and nickel.

As best seen in FIG. 3, the substrate 102 is porous, including numerous pores 110, and zero valent nanoparticles 106 are disbursed on the surface of the substrate 102 and within at least some of the pores 110. It is desirable to employ a porous surface in order to increase the available active surface area on which to immobilize the zero valent nanoparticles 106. In this regard, it has been found desirable that the inorganic substrate 102 have a porosity of one of: (i) between about 20%-90%; (ii) between about 40°-700; and (iii) between about 50%-60%.

In order to increase the available active surface area of the substrate 102, the surface may be coated with an inorganic oxide 104 prior to immobilizing the zero valent nanoparticles 106. Indeed, as shown in FIG. 3, particles of the inorganic oxide 104 may be coated onto the porous surface of the substrate 102. The inorganic oxide may be one or more of SiO2, Al2O3, CeO2, ZrO2, TiO2, SnO2, MgO, ZnO, Nb2O5, Cr2O3, CdO, and WO3. The change in the microscopic contour of the surface introduced by the geometries of the particles of the inorganic oxide 104 increases the available active surface area of the substrate 102, providing more opportunities and surfaces to immobilize the zero valent nanoparticles 106. In one or more embodiments, the active surface area (intended to receive the zero valent nanoparticles 106) may be considered to be an aggregate of: (i) portions of the surface of the inorganic substrate 102, and (ii) portions of the surfaces particles of the inorganic oxide 104 that are adhered to the surface of the inorganic substrate 102.

In order to effectively treat the contaminated water 20, a large percentage of the available active surface area of the substrate 102 should be covered with the zero valent nanoparticles 106, such as ranging one of: (i) between about 20%-100%; (ii) between about 40%-90%; (iii) between about 50°-900; and (iv) between about 70%-80%.

It has been found that a relationship between the geometries of the particles of the inorganic oxide 104 and the pores 110 of the substrate 102 should be considered. Indeed, in order to facilitate good adhesion of the particles of the inorganic oxide 104 to the surface, and therefore improve the available active surface area of the substrate 102, the sizes of the pores 110 should be complimentary to the sizes of the particles of the inorganic oxide 104. The contemplated inorganic oxide 104 may exhibit particle diameters of between about: (i) 10 nm to about 100 nm, (ii) about 30 nm-80 nm, and (iii) about 40 nm-50 nm (where about 40 nm is typical). Accordingly, one may seek to provide pores 110 that are large enough to adequately receive the inorganic oxide 104, such as one of: (i) between about 20 nm-30 um; (ii) greater than about 20 nm; and (iii) between about 10 um-30 um. For purposes of discussion, one can see that the ranges for the pore sizes correspond to and/or complement the ranges of the size of the inorganic oxide 104.

The sizes (approximate diameters) of the zero valent nanoparticles 106 range from about 5 nm and higher, such as to about 40-50 nm. Typically, practical and cost-effective methodologies for producing zero valent nanoparticles 106 will result in particle sizes of between about 5 nm to about 10 nm at the low end of the scale. For purposes of the embodiments herein, it is desirable to employ zero valent nanoparticles 106 with relatively small diameters in order to maximize the surface area available to remove the heavy metal contaminants from the water 20.

A stabilizer 108 may be applied to the zero valent nanoparticles 106 in order to inhibit oxidation, which is an inherent problem with such material. The stabilizer 108 may include at least one of activated carbon, graphene, and an inorganic oxide, for example, SiO2, Al2O3, CeO2, ZrO2, TiO2, SnO2, MgO, ZnO, Nb2O5, Cr2O3, CdO, and/or WO3. Alternatively or additionally, the stabilizer 108 may include organic, polymer materials, such as: xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof. The stabilizer 108 may wholly or partially coat the zero valent nanoparticles 106.

The methodologies for producing the basic structure 100 include: providing the inorganic substrate 102 having at least one surface; immobilizing the zero valent nanoparticles 106 on the at least one surface; and stabilizing the zero valent nanoparticles 106 to inhibit oxidation thereof. In order to ensure good adhesion between the inorganic substrate 102 and the immobilized zero valent nanoparticles, and in order to increase the available active surface area of the substrate 102, the substrate 102 may be pre-coated with an inorganic oxide 104 of, for example, SiO2, Al2O3, CeO2, ZrO2, TiO2, SnO2, MgO, ZnO, Nb2O5, Cr2O3, CdO, and/or WO3. For example, the pre-coating step may be carried out by dipping the substrate 102 in a colloidal solution (e.g., 30% or 40% LUDOX silica solution). It has been found that the pre-coating step is desirably carried out such that between about 10-40 weight % of the inorganic oxide 104 is coated on the inorganic substrate 102.

After pre-coating, the zero valent nanoparticles 106 are immobilized on the substrate 102. There are a number of methodologies suitable for the immobilization step. For example, one approach includes impregnating the inorganic substrate 102 with a salt containing a precursor for the zero valent nanoparticles 106. For example, when zero valent iron nanoparticles are employed the salt may be, for example, iron chloride, iron sulfate and/or iron nitrate. Next, the impregnated inorganic substrate 102 is brought into contact with an aqueous-alcohol suspension or dispersion, e.g., by dipping the substrate 102 in a bath. Next, a reducing agent is added to the aqueous-alcohol suspension or dispersion in order to reduce the salt to the elemental zero valent nanoparticles. By way of example, the reducing agent may be sodium borohydride, also known as sodium tetrahydridoborate (NaBH4), which may be added under agitation. The substrates 102 are then removed and dried, preferably at temperature.

In an alternative approach, the inorganic substrate 102 is impregnated with a salt containing a precursor for the zero valent nanoparticles 106. Thereafter, the substrate 102, particularly the salt, is subject to elevated temperature and an H2 environment, which reduces the salt to the elemental zero valent nanoparticles 106.

In a further alternative, the step of immobilizing the zero valent nanoparticles 106 on the surface of the substrate 102 includes: bringing the inorganic substrate 102 into contact with a stable suspension or dispersion of the zero valent nanoparticles 106; and drying the inorganic substrate 102, such as in a nitrogen atmosphere.

The zero valent nanoparticles 106 are stabilized, such as by coating with at least one of activated carbon, graphene, and an inorganic oxide. In one or more embodiments, the zero valent nanoparticles 106 are stabilized after immobilization on the substrate 102. In alternative embodiments, however, the zero valent nanoparticles 106 may be stabilized before immobilization.

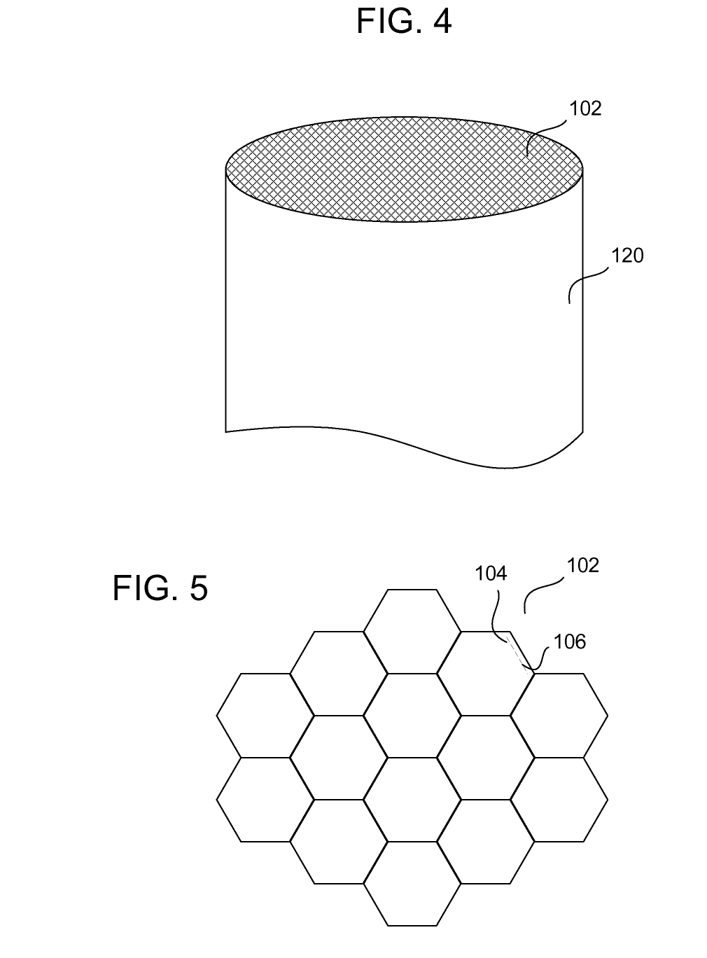

With reference to FIGS. 4 and 5, a preferred configuration is illustrated. FIG. 4 is a perspective view of an embodiment in which the substrate 102 is implemented using a honeycomb structure 120, and FIG. 5 is an end view of the honeycomb structure 120. Accordingly, the inorganic substrate 102 includes a plurality of parallel channels, where each channel is formed by a plurality of interior surfaces forming the at least one surface of the substrate 102. Thus, in FIG. 5, reference is made to the inorganic oxide 104 and the zero valent nanoparticles 106 on the interior surfaces of the honeycomb channels. In order to treat wastewater 20 contaminated with one or more heavy metals, the water 20 is directed to flow through the cells of the honeycomb, which brings the contaminated water 20 into contact with the surfaces containing the immobilized zero valent nanoparticles 106. Consequently, the heavy metal is removed (at least partially) from the water 20.

It is noted that the channels of the honeycomb structure 120 are defined by respective walls (which may be individually considered to be a substrate 102). Each wall is preferably porous, such as is shown in the microscopic view of the substrate 102 of FIG. 3. Although not specifically shown in FIG. 3, some of the pores 110 may extend all the way through a given wall and communicate with an adjacent channel of the honeycomb structure 120. Consequently, the zero valent nanoparticles 106 may exist within such pores 110 that extend all the way through such wall.

A number of experiments were conducted in order to evaluate a number of performance characteristics of the methodologies and apparatus disclosed herein.

In order to conduct adsorption studies, a number of cordierite honeycomb samples coated with stabilized ZVI nanoparticles were immersed in (and then removed from) 45 ml of FGD wastewater containing 30 ppb As, 200 ppb Cd, 2.5 ppm Se, 160 ppb Hg, 220 ppm sulfate, 100 ppm nitrate, 31 ppm chloride, 58 ppm calcium, 17 ppm magnesium and 11 ppm sodium. During the immersion, the adsorbent structure 100 and the wastewater were agitated on a mechanical shaker for sixteen hours. The changes in metal ion concentrations due to adsorption were determined, where the amounts of adsorbed metal ions were calculated from differences between their concentrations before and after adsorption.

In a first example, a number of silica-coated cordierite honeycomb substrates were immersed in 100 ml DI-water containing 80 g FeSO4.7H20 and 12.6 g ascorbic acid for ten minutes. After immersion, the substrates were dried at 100° C. for 30 minutes. The immersion and drying cycle was repeated twice, after which the weight gained by each substrate was calculated. Next, the substrates were immersed in a 40% ethanol solution. To reduce the impregnated iron salts to elemental iron, a stoichiometric amount of NaBH4, corresponding to the total weight gain, was added to the ethanol solution. After permitting reaction for twenty minutes, the substrates were removed from the solution, washed twice in ethanol, and dried in an N2 atmosphere. Finally, the zero valent iron nanoparticles were stabilized by dipping the substrates in a 10 wt % colloidal silica solution for two minutes and drying the substrates at 100° C. under an N2 atmosphere.

Below, TABLE 1 is a table of data showing the efficacy of the system for treating contaminated water according the first experiment. The table shows the concentration of metals of concern in the wastewater before and after treatment. An analysis of the residual concentration of the metals reveals that the methodology and apparatus resulted in excellent removal performance of heavy metal ions by the adsorbent.

TABLE 1

| Metal | Concentration Before | | Concentration After |
|---|---|---|---|
| As | 30 | ppb | <5 ppb |
| Cd | 200 | ppb | <5 ppb |
| Hg | 160 | ppb | <5 ppb |
| Se | 2.3 | ppm | 60 ppb |

In a second example, 20 g of FeSO4.7H20 and 3.17 g of ascorbic acid were dissolved in 100 ml of DI-water. Next, 0.75M of NaBH4 in 50 ml of DI-water (2.837 g) was added in a drop-wise fashion with vigorous stirring, during which the solution slowly turned to a black color. The black colored particles were washed two times with absolute ethanol. Next, 100 ml of ethanol was added to the washed particles. Next, 10 ml of 40 wt % colloidal silica was added to the mixture. The mixture was then sonicated for four minutes to form a stable suspension of ZVI nanoparticles. A number of silica-coated cordierite honeycomb substrates were dipped into the solution for ten minutes. After clearing the channels of the honeycomb substrate, the substrates were dried at 70° C. under an N2 atmosphere for thirty minutes. After three cycles of dipping and drying, the substrates samples were dried under an N2 atmosphere. Finally, the zero valent iron nanoparticles were stabilized by dipping the substrates in a 10 wt % colloidal silica solution for two minutes and drying the substrates at 100° C. under an N2 atmosphere.

Below, TABLE 2 is a table of data showing the efficacy of the system for treating contaminated water according the second experiment. The table shows the concentration of metals of concern in the wastewater before and after treatment. An analysis of the residual concentration of the metals reveals that the methodology and apparatus again resulted in excellent removal performance of heavy metal ions by the adsorbent.

TABLE 2

| Metal | Concentration Before | | Concentration After |
|---|---|---|---|
| As | 30 | ppb | <5 ppb |
| Cd | 200 | ppb | <5 ppb |
| Hg | 160 | ppb | <5 ppb |
| Se | 2.3 | ppm | 70 ppb |

In a third example, 140 g of Fe(NO3)3.9H20 was dissolved in 100 ml of DI-water. Next, a number of silica-coated cordierite honeycomb substrates were immersed in the solution for ten minutes. After immersion, the substrates were dried at 100° C. for thirty minutes. After three cycles of dipping and drying, the substrates were treated in an H2 atmosphere at 700° C. for three hours to form ZVI nanoparticles. Finally, the zero valent iron nanoparticles were stabilized by dipping the substrates in a 10 wt % colloidal silica solution for two minutes and drying the substrates at 100° C. under an N2 atmosphere.

Below, TABLE 3 is a table of data showing the efficacy of the system for treating contaminated water according the third experiment. The table shows the concentration of metals of concern in the wastewater before and after treatment. An analysis of the residual concentration of the metals reveals that the methodology and apparatus again resulted in excellent removal performance of heavy metal ions by the adsorbent, particularly for As, Cd, and Hg.

TABLE 3

| Metal | Concentration Before | | Concentration After | |
|---|---|---|---|---|
| As | 30 | ppb | <5 | ppb |
| Cd | 200 | ppb | <5 | ppb |
| Hg | 160 | ppb | <5 | ppb |
| Se | 2.3 | ppm | 0.55 | ppm |

It is noted that the methodologies, apparatus, and/or mechanisms described in one or more embodiments herein involve the adsorption of the heavy metal onto the functionalized surface (the surface having the immobilized and stabilized zero valent nanoparticles) of the substrate 102. In this regard, the substrate 102 carries the heavy metal contaminant(s) out of or away from the treated water, and therefore the heavy metal remains adsorbed on the substrate 102 after such treatment has been completed.

One option for disposing of the heavy metal is simply to discard the used substrate 102, such as in a landfill or other modality. Alternatively, skilled artisans may employ any number of well-known regeneration procedures to remove the heavy metal from the substrate 102 and therefore permit reuse of the substrate 102 in subsequent treatment procedures. The known regeneration procedures fall into two categories: (i) those that selectively remove the heavy metal; and (ii) those that remove at least the zero valent nanoparticles, and possibly the pre-coating and/or stabilizing particles. If the regeneration methodology removes the zero valent nanoparticles and/or the pre-coating and/or the stabilizing particles, then the substrate 102 may be re-functionalized using the techniques described herein to immobilize and stabilize further zero valent nanoparticles on the substrate 102.

Although the disclosure herein has been described with reference to particular embodiments, it is to be understood that the details thereof are merely illustrative of the principles and applications of such embodiments. It is therefore to be understood that numerous modifications may be made to the illustrative embodiments and that other arrangements may be devised without departing from the spirit and scope of the present application.

Additional aspects of zero valent nanoparticles are disclosed in co-pending U.S. application Ser. No. ______, filed Jun. 26, 2013, entitled “METHODS AND APPARATUS FOR MULTI-PART TREATMENT OF LIQUIDS CONTAINING CONTAMINANTS USING ZERO VALENT NANOPARTICLES,” (Attorney Docket No. SP13-195) and in co-pending U.S. application Ser. No. ______, filed Jun. 26, 2013, entitled “METHODS AND APPARATUS FOR SYNTHESIS OF STABILIZED ZERO VALENT NANOPARTICLES,” (Attorney Docket No. SP13-177) the contents of each are hereby incorporated by reference in their entirety.

As used herein, the singular forms “a,” “an” and “the” include plural referents unless the context clearly dictates otherwise. Thus, for example, reference to a “stabilizer” includes examples having two or more such “stabilizers” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises an inorganic substrate, zero valent nanoparticles, and a stabilizer engaging the zero valent nanoparticles include embodiments where an apparatus consists of an inorganic substrate, zero valent nanoparticles, and a stabilizer engaging the zero valent nanoparticles and embodiments where an anode consists essentially of an inorganic substrate, zero valent nanoparticles, and a stabilizer engaging the zero valent nanoparticles.

1. An apparatus, comprising:
an inorganic substrate having at least one surface having a plurality of pores;
zero valent nanoparticles deposited on the at least one surface and within at least some of the pores; and
a stabilizer engaging the zero valent nanoparticles and operating to inhibit oxidation of the zero valent nanoparticles.

2. The apparatus of claim 1, wherein the zero valent nanoparticles include at least one of iron, lithium, and nickel.

3. The apparatus of claim 1, wherein at least one of:
the stabilizer includes at least one of activated carbon, graphene, an inorganic oxide, and an organic material;
the inorganic oxide is at least one of SiO2, Al2O3, CeO2, ZrO2, TiO2, SnO2, MgO, ZnO, Nb2O5, Cr2O3, CdO, and WO3; and
the organic material is at least one of xanthan polysaccharide, polyglucomannan polysaccharide, emulsan, an alginate biopolymer, hydroxypropyl methylcellulose, carboxy-methyl cellulose, ethyl cellulose, chitin, chitosan, polyvinyl alcohol, polyvinyl esters, polyvinyl amides, copolymers of polylactic acid, and combinations thereof.

4. The apparatus of claim 1, wherein the inorganic substrate is one of ceramic and alumina.

5. The apparatus of claim 4, wherein the inorganic substrate is ceramic having a porosity of one of: (i) between about 20%-90%; (ii) between about 40%-70%; and (iii) between about 50%-60%.

6. The apparatus of claim 4, wherein the inorganic substrate is ceramic and the pores are of a size of one of: (i) between about 20 nm-30 um; (ii) greater than about 20 nm; and (iii) between about 10 um-30 um.

7. The apparatus of claim 1, wherein the zero valent nanoparticles cover a percentage of an active surface area of the at least one surface ranging one of: (i) between about 20%-100%; (ii) between about 40%-90%; (iii) between about 50%-90%; and (iv) between about 70%-80%.

8. The apparatus of claim 7, wherein the active surface area is an aggregate of: (i) portions of the at least one surface of the inorganic substrate, and (ii) portions of an inorganic oxide adhered to the at least one surface of the inorganic substrate.

9. The apparatus of claim 8, wherein the inorganic oxide includes a plurality of particles having diameters within a range of one of: (i) about 10 nm-100 nm; (ii) about 30 nm-80 nm; and (ii) about 40 nm-50 nm.

10. The apparatus of claim 1, wherein the inorganic substrate is a ceramic honeycomb structure having a plurality of parallel channels, where each channel is formed by a plurality of interior surfaces forming the at least one surface.

11. A method, comprising:
providing an inorganic substrate having at least one surface having a plurality of pores;
immobilizing zero valent nanoparticles on the at least one surface and within at least some of the pores; and
stabilizing the zero valent nanoparticles to inhibit oxidation of the zero valent nanoparticles.

12. The method of claim 11, further comprising:
coating the inorganic substrate with an inorganic oxide prior to immobilizing the zero valent nanoparticles on the at least one surface,
wherein the inorganic oxide is at least one of SiO2, Al2O3, CeO2, ZrO2, TiO2, SnO2, MgO, ZnO, Nb2O5, Cr2O3, CdO, and WO3.

13. The method of claim 12, wherein the coating step is carried out such that between about 10-40 weight % of the inorganic oxide is coated on the inorganic substrate.

14. The method of claim 11, wherein the step of immobilizing the zero valent nanoparticles on the at least one surface includes:
impregnating the inorganic substrate with a salt containing a precursor for the zero valent nanoparticles; and
applying a reducing agent in order to reduce the salt to the elemental zero valent nanoparticles.

15. The method of claim 11, wherein the step of immobilizing the zero valent nanoparticles on the at least one surface includes:
bringing the inorganic substrate into contact with a stable suspension or dispersion of the zero valent nanoparticles; and
drying the inorganic substrate.

16. The method of claim 11, wherein the zero valent nanoparticles include at least one of iron, lithium, and nickel.

17. The method of claim 11, wherein:
the step of stabilizing the zero valent nanoparticles includes coating the zero valent nanoparticles with at least one of activated carbon, graphene, and an inorganic oxide; and
the inorganic oxide is at least one of SiO2, Al2O3, CeO2, ZrO2, TiO2, SnO2, MgO, ZnO, Nb2O5, Cr2O3, CdO, and WO3.

18. The method of claim 11, wherein the inorganic substrate is a ceramic honeycomb structure having a plurality of parallel channels, where each channel is formed by a plurality of interior surfaces forming the at least one surface.

19. A method of treating water contaminated with one or more heavy metals, comprising:
providing an inorganic substrate having at least one surface having a plurality of pores, zero valent nanoparticles deposited on the at least one surface and within at least some of the pores, and a stabilizer engaging the zero valent nanoparticles and operating to inhibit oxidation of the zero valent nanoparticles;
bringing the contaminated water into contact with the at least one surface to remove the heavy metal from the water.

20. The method of claim 19, wherein:
the inorganic substrate is a ceramic honeycomb structure having a plurality of parallel channels, where each channel is formed by a plurality of interior surfaces forming the at least one surface; and
the method further comprises flowing the contaminated water through the plurality of parallel channels to bring the water into contact with the at least one surface and to remove the heavy metal from the water.
